(19) United States
(12) Patent Application Publication
(10) Pub. No.: US 2008/0272109 A1
(43) Pub. Date: Nov. 6, 2008

(54) Bistro Table Heater with Heat Guard Rail

(75) Inventors: Griffin Bland, Bowling Green, KY (US); Jeff Clack, Bowling Green, KY (US); Pete Moyer, Bowling Green, KY (US); Chungkin Yee, Bowling Green, KY (US); Ken Maitland, Bowling Green, KY (US); Jerry McColgin, Westfield, IN (US); Maureen Carroll, Atlanta, GA (US); Michael E. Docherty, Boca Raton, FL (US)

Correspondence Address: MIDDLETON & REUTLINGER, 2500 BROWN & WILLIAMSON TOWER, LOUISVILLE, KY, 40202, US

(73) Assignee: DESA IP, LLC, Miami, FL (US)

(21) Appl. No.: 11/684,958

(22) Filed: Mar. 12, 2007

(51) Int. Cl. H05B 1/00

(52) U.S. Cl. 219/218

(57) ABSTRACT

In one embodiment the instant invention combines a table and a heater in one device. The heater contains a heating element, which may use propane as a fuel source. The fuel source of the invention may be self-contained so that the heater is portable. The table may have several deflectors below and above the heater it so that the table does not get hot. The invention may also have a heat guard rail attached to the table and extending away from the table to guard against users inadvertently touching the heating area of the invention.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

### Field of the Invention

The present invention relates to a combination table and heater. More particularly, the invention relates to a pillar heater having a table with a guard rail that can be used for outdoor dining and recreation.

### BRIEF DESCRIPTION OF THE DRAWINGS

The aspects and advantages of the present invention will be better understood when the detailed description of the preferred embodiment is taken in conjunction with the accompanying drawings, in which:

FIG. 1 is a plan view of one embodiment of the invention;

FIG. 2 is a plan view of another embodiment of the invention;

FIG. 3 is a plan view of another embodiment of the invention;

FIG. 4 is a plan view of another embodiment of the invention;

FIG. 5 is an exploded view of an embodiment of the invention;

FIG. 6 is an exploded view of the base and support pillars of the invention;

FIG. 7 is a perspective view of a cabinet assembly of the invention;

FIG. 8 is an exploded view of an embodiment of the heating area of the invention;

FIG. 9 is an exploded view of a grate and emitter assembly of the invention;

FIG. 10 is an exploded view of the emitter assembly of the invention;

FIG. 11 is a perspective view of an embodiment of the grate of the invention;

FIG. 12 is an exploded view of the deflector pans of one embodiment of the invention;

FIG. 13 is an exploded view of an embodiment of the table of the invention; and

FIG. 14 is a perspective view of one embodiment of the invention.

### DETAILED DESCRIPTION OF THE DRAWINGS

While this invention is capable of embodiments in many different forms, multiple embodiments are shown in the figures and will be herein described in detail. The present disclosure is to be considered an exemplification of the principles of the invention and is not intended to limit the broad aspects of the invention to the embodiments illustrated.

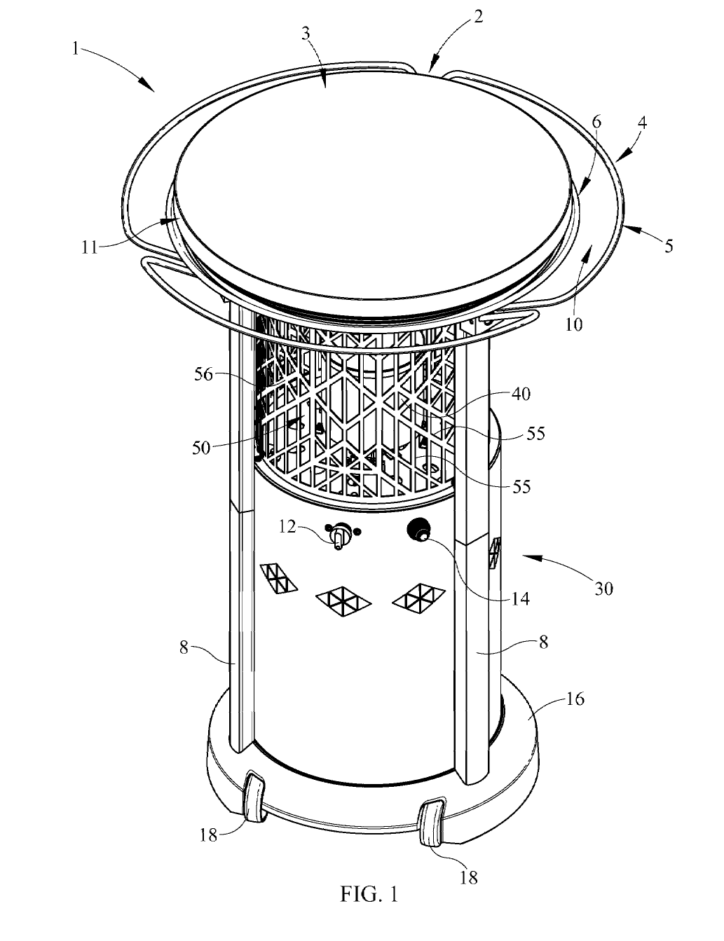

Referring now to FIG. 1, in one embodiment the bistro table heater 1 of the invention comprises a table 2 having a heating area 50 below it. The heating area or heating chamber 50 comprises a heat source, which in FIG. 1 is a radiant emitter assembly 40 positioned below the table 2. Heat emanates from the heating area 50 in a 360 degree pattern around the bistro table heater 1 due to the burner and the grate 56 of the heating area 50. The heating area 50 is covered by a grate 56 having many a plurality of apertures 55. The apertures 55 of the grate 56 allow heat out of the heating area, but the grate 56 partially shields the heat source of the heating area 50 from weather or other physical interference. While apertures 55 are shown in one embodiment, the wall of the heating area 50 may also be constructed with slots, openings or simple continuous heat radiating surfaces, all designed to allow heat to radiate outward from the chamber 50.

In the embodiment shown in FIG. 1, the table 2 is surrounded by a heat guard rail 4 attached to the support pillar 8. The heat guard rail 4 allows people sitting or standing near the table heater 1 to lean against the rail 4 for support. The heat guard rail 4 has an outside edge 5 that defines an extended area 10 between the heat guard rail 4 and the table 2. In the embodiment shown in FIG. 1, the extended area 10 is an empty space, although it may comprise other configurations and connections to the heater 1. The heat guard rail 4 causes people to maintain a distance at least the width of the extended area 10 from the heating area 50. Given its relatively close proximity to the heating area 50, the table 2 may become somewhat warm after extended use, but due to the design of the table heater 1, the temperature of the table 2 should not become elevated enough to cause pain or discomfort to anyone who leans against it, even if they do so for an extended period of time.

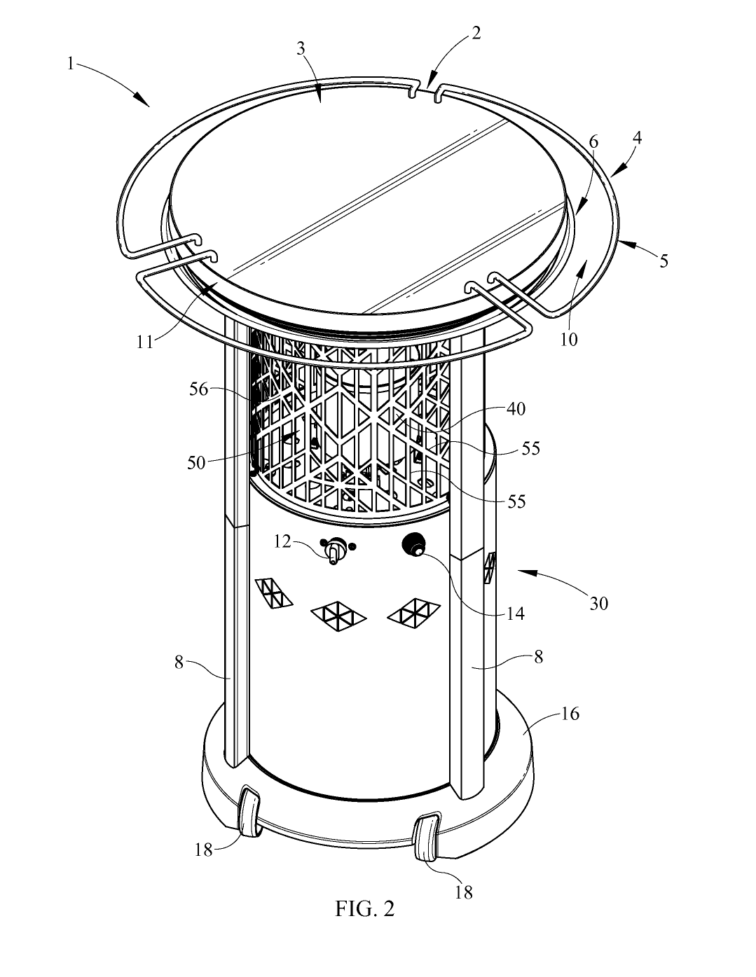

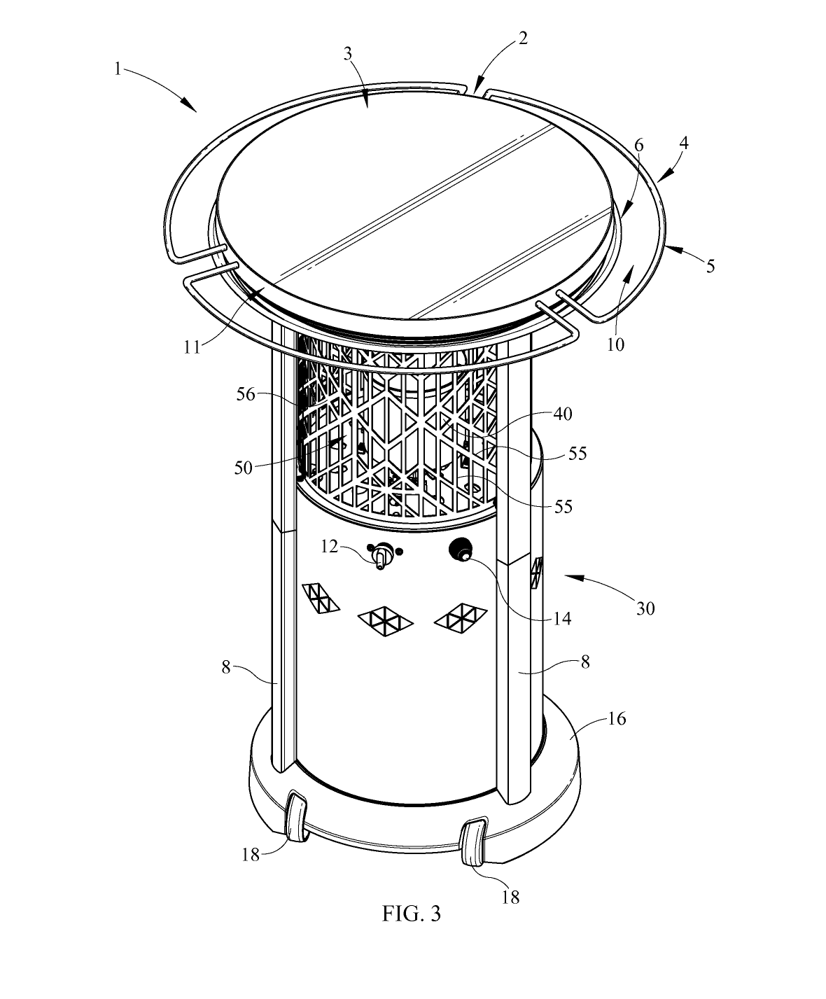

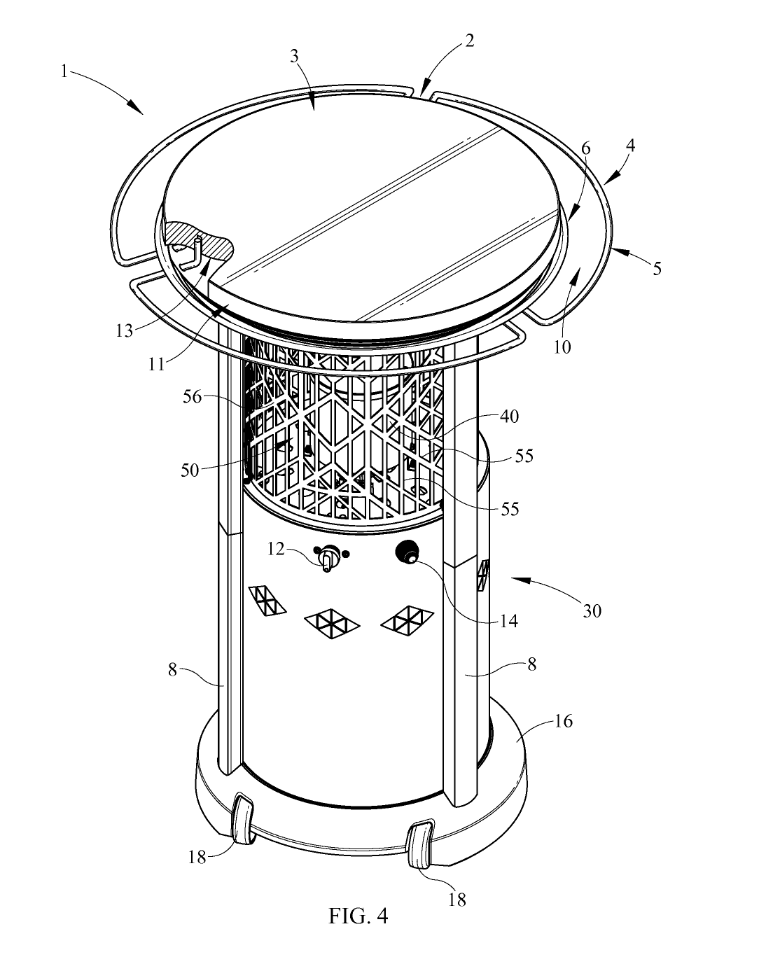

In FIG. 1, the heat guard rails 4 are inserted into the support pillars 8, but they may also be inserted directly into the table 2. The table 2 has a table top 3, a table edge 11, and a table bottom 13, and the heat guard rail may be attached to the heater 1 at any of these locations, as shown in FIGS. 2, 3, and 4, respectively. Alternatively, the heat guard rail 4 may be attached to other parts of the heater 1.

Below heating area 50 is cabinet assembly 30, which will be more fully described below. Generally, cabinet assembly 30 has enough space to store the energy source for the heat source so that the table heater 1 functions as a self-contained unit, and can be easily moved as desired. The energy source, a propane tank in one embodiment, should fit within the cabinet assembly 30 and rest on base 16. In the embodiment shown in FIG. 1, base 16 has wheels 18 that ensure the mobility of table heater 1.

The embodiment shown in FIG. 1 further comprises a control knob 12 and ignitor 14 located on the outside of the cabinet assembly 30. Several support pillars 8 vertically extend along the length of the table heater 1 at several places on the heater. The support pillars 8 connect to each other and to other parts of the table heater 1 in order to maintain the physical integrity of the entire structure.

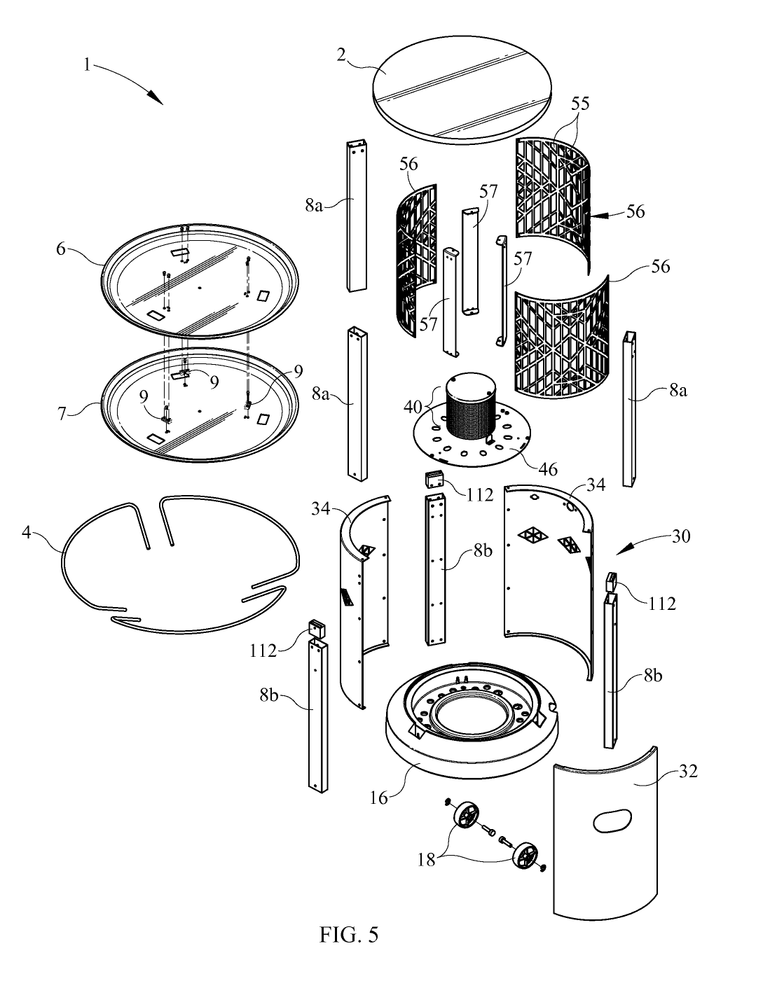

Turning now to FIG. 5, the invention may have one or more deflectors 6, 7 below the table 2. The deflectors 6, 7 redirect heat away from the table 2 so that the table 2 remains cool even when the table heater 1 emits a large amount of heat. Below the table 2 is a heat source, which in FIG. 5 is an emitter assembly 40. In another embodiment of the invention, the heat source may comprise a ring burner. The emitter assembly 40 is located a sufficient distance away from the deflectors 6, 7 so that a great deal of heat emanates peripherally out through one or more apertures 55 in grate 56 before coming in contact with deflectors 6, 7. Grates 56 are not necessary for the table heater 1 to function, but they improve its aesthetics and prevent outside interference with the heat source.

Located further below the heating area is a cabinet assembly 30. The cabinet assembly 30 comprises several control panels 32, 34. In the embodiment shown in FIG. 5, the cabinet assembly comprises a door panel 32 and one or more control panels 34. The door panel 32 can be used to open the cabinet assembly 30 so that a propane tank or other energy source can be stored within the heater table 1. The energy source of the heater is self-contained, thereby making the heater table 1 easily portable.

In one embodiment, the bistro table heater 1 comprises one or more support pillars 8 that add stability and rigidity to the design of the table. In the embodiment shown in FIG. 5, the support pillars 8 can vertically traverse the length of the table heater 1 up to the deflectors 6, 7 at different points on each perimeter. The support pillars 8 are spaced at intervals around the heater 1 to ensure that the whole of the heating area 50 and the cabinet assembly 30 are adequately supported. A sturdy base 16 sits at the bottom of the table heater 1 and allows the table heater 1 to stay in one place on the ground. The table heater should not fall over or lean.

In one embodiment of the invention, the base 16 has wheels 18 which allows for very easy portability. If the table heater 1 were used with outdoor seating on a patio or at a restaurant, for example, portability could be an important feature.

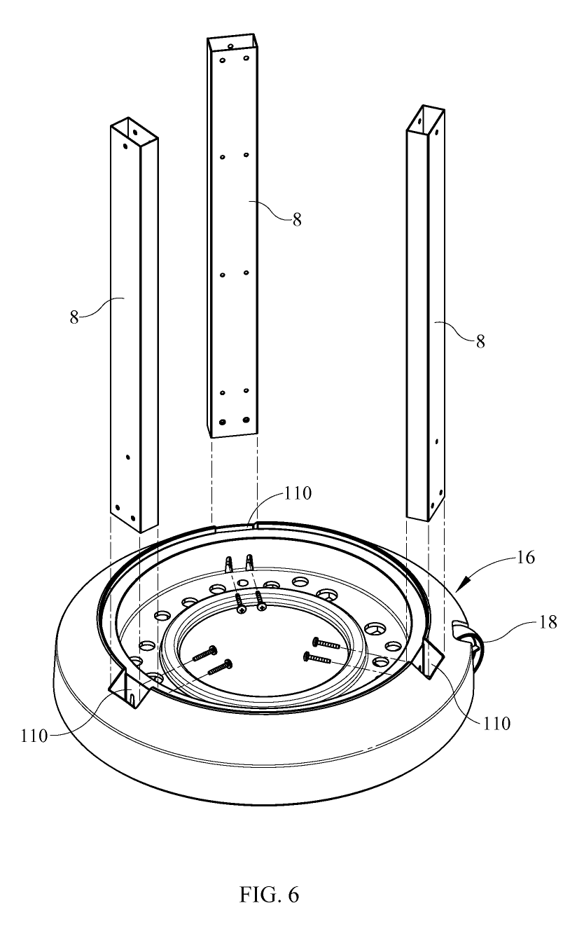

FIG. 6 shows how the support pillars 8 attach to the base 16, and wheels 18 are also visible. In the embodiment shown in FIG. 5, the pillars 8 are hollow and are made of a strong metal material. The bottom of the individual pillars 8 insert into notches 110 in base 16 and are then attached to the base 16 by screws.

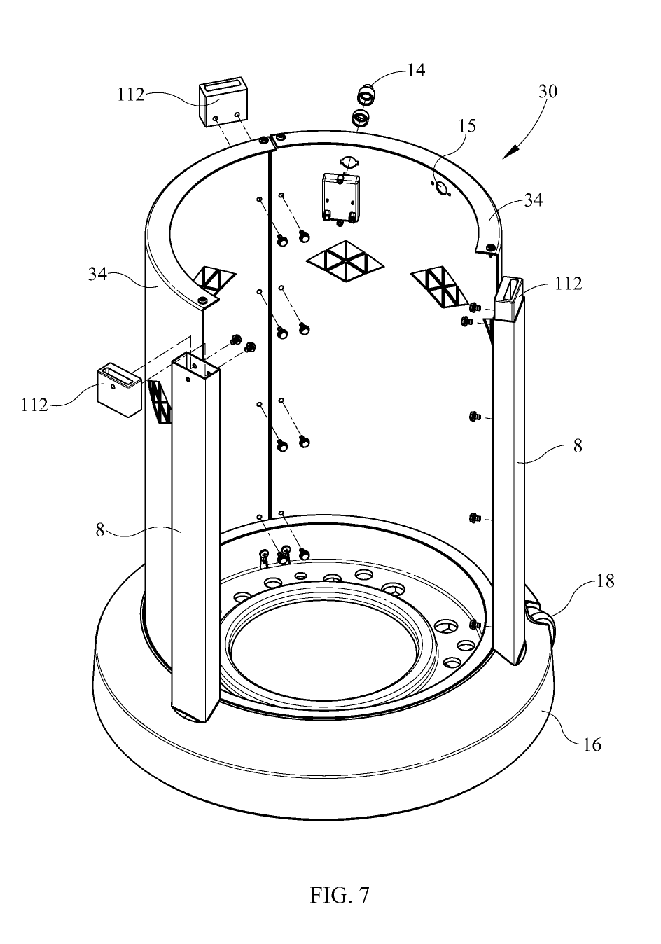

As shown in FIGS. 6 and 7, wheels 18 are rotatably attached to base 16. Base 16 is hollow and allows a good deal of space for a propane tank or other energy source. The cabinet assembly 30 generally comprises control panels 32, and door panel 34. Door panel 34 can be opened in order to remove the propane tank after it is empty. Ignitor 14 is also shown in FIG. 7, as is a hole 15 for the control knob 12. Brackets 112 can be attached to support pillars 8 in order to secure control panels 32 in place on top of base 16. As shown in FIG. 7, screws or other fasteners can be used for this purpose.

As is also shown in FIG. 7, base 16 sits at the very bottom of table heater 1 for support. Other types of support structures can also be used with the table heater 1 of the embodiment, but base 16 is especially useful because it is capable of holding a 20 1b. propane tank so that it fits snugly within cabinet assembly 30 and does not teeter or wobble. The snug fit of the energy source in the base 16 and cabinet assembly 30 ensures a consistent and stable support for the heat source so that heat consistently emanates from the table heater 1.

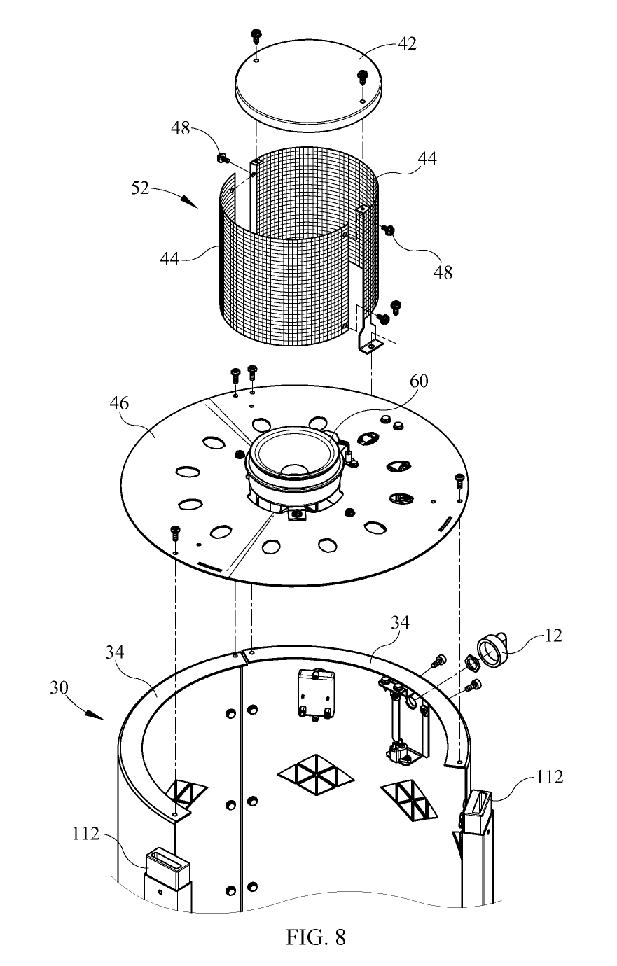

In the embodiment of the invention shown in FIG. 8, the heat source of heating area 50 comprises an emitter assembly 40. The emitter assembly 40 comprises one or more emitter screens 44 that can be joined together by screws 48 or other fasteners and covered by an emitter cap 42. The emitter screen 44 shown in FIG. 8 is cylindrical, but the emitter screen 44 may also be cubical or any other shape that encloses enough space for a burner 60. The emitter screen 44 of FIG. 8 comprises wire mesh and has many small openings, which allows heat from the burner 60 to escape.

Below the emitter assembly 40 is a burner support plate 46 to which the burner 60 may be attached. It can be seen that when the emitter screen 44 is attached to the burner support plate 46, its radius is approximately half the radius of the burner support plate 46. Having a heat source that is too large could cause excessive heat to be generated from the heating area 50. As is also visible in FIG. 7, screws or other fasteners attach burner support plate 46 to cabinet assembly 30. Control knob 12 can also be attached to one of the control panels 32.

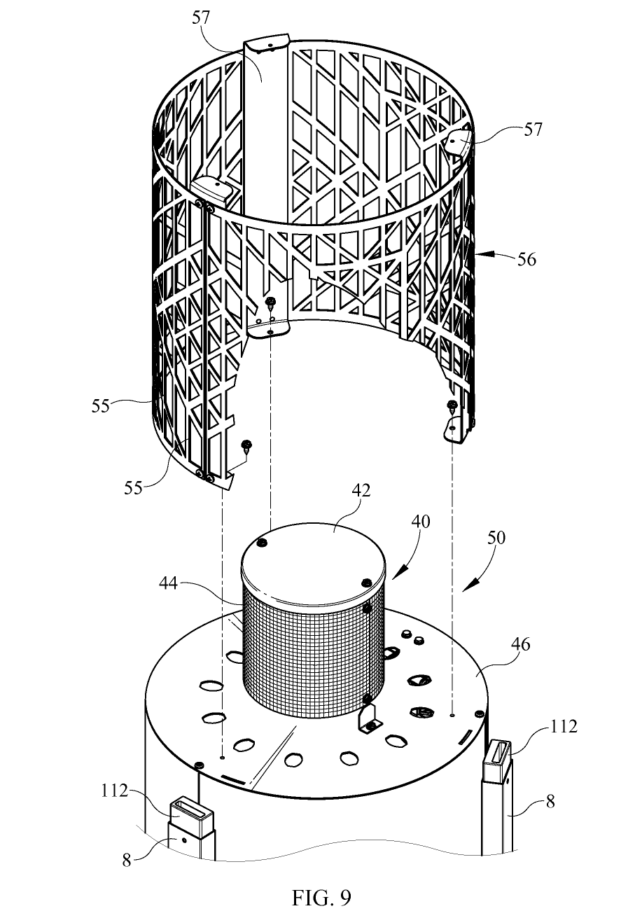

Turning now to FIG. 9, once the emitter assembly 40 is attached to the burner support plate 46, grate 56 can be attached to the burner support plate 46 around emitter assembly 40 so that the grate 56 encloses heating area 50. The grate 56 acts to partially shield the combustion chamber 50 from weather interference with the operation of the heat source, and can limit inadvertent user contact with the heating area or combustion chamber 50.

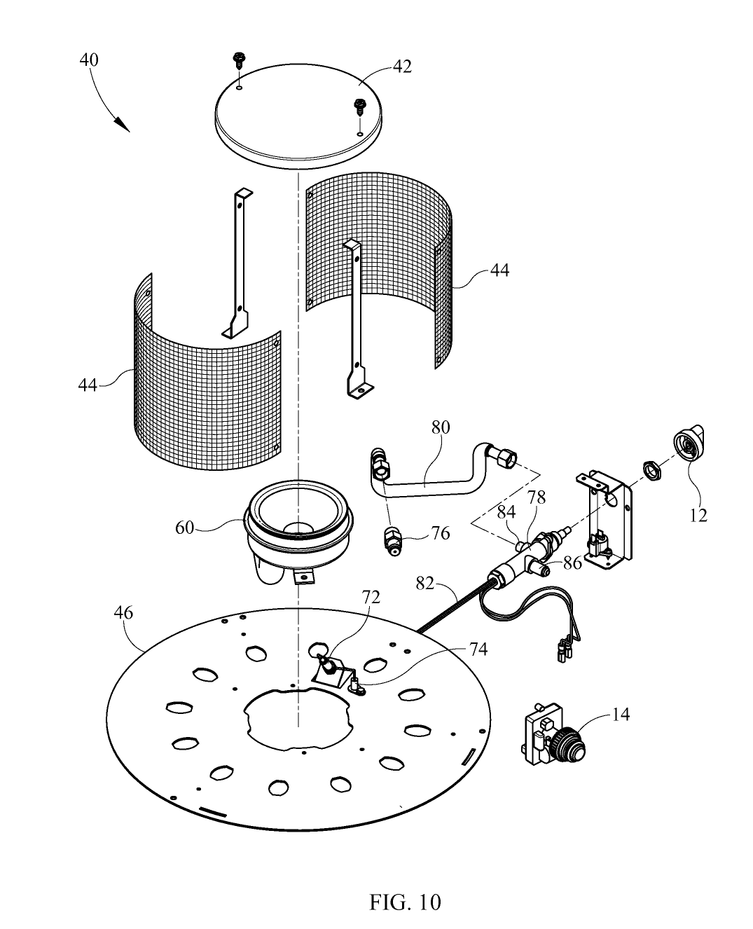

Turning now to FIG. 10, control knob 12 controls the activation of burner 60 within emitter assembly 40. When control knob 12 is pressed and turned, control valve 78 opens, and gas flows through first fitting 84 and burner flex line 80 into injector 76, which in turn injects the gas into burner 60. Gas enters control valve 78 through second fitting 86, which connects to a propane tank or other energy source through a conventional hose and regulator (not shown). When ignitor 14 is depressed, an electronic signal is sent through a wire to ignitor electrode 74 on burner plate 46 so that a spark ignites gas coming through injector 76 to burner 60. When burner 60 ignites, thermocouple 72 sends a signal through thermocouple wire 82 to control valve 78, which activates control valve 78 to stay open. Conversely, if burner 60 goes out, thermocouple 72 senses that condition and sends a signal to control valve 78 activating it to close. When burner 60 is lit, emitter screens 44 absorb heat radiated from burner 60, causing screens 44 to glow red and radiate heat outward through grate 56.

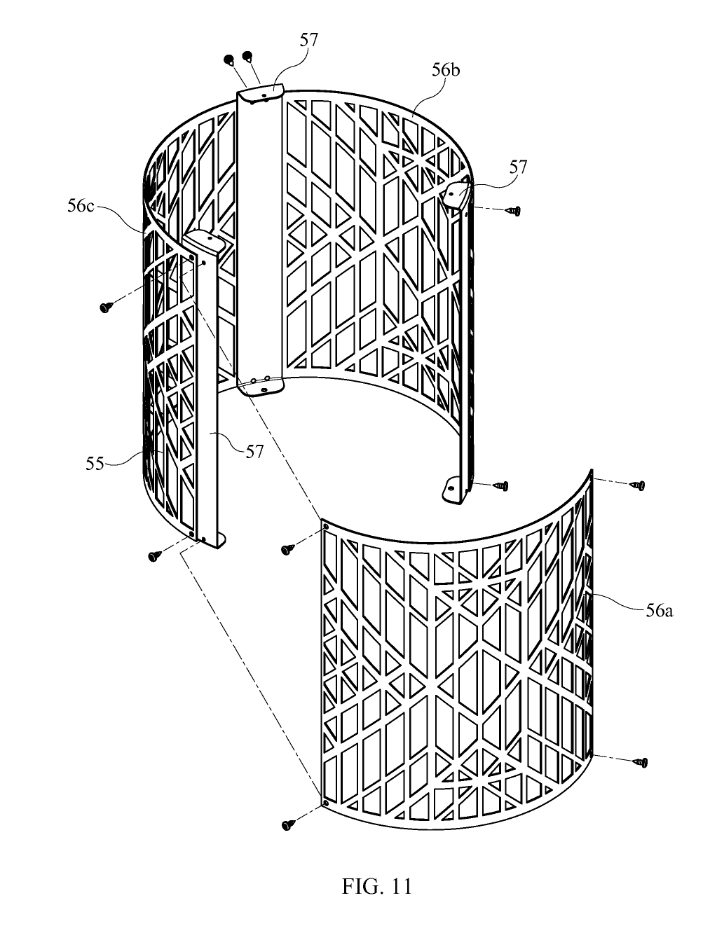

Grate 56 may comprise more than one piece. For example, in the embodiment shown in FIG. 11, for example, grate 56 is formed from three semi-circular segments 56a, 56b, 56c, that are attached to grate pillars 57 and joined together.

Grate pillars 57 maintain the shape of grate 56, which circumscribes heating area or combustion chamber 50.

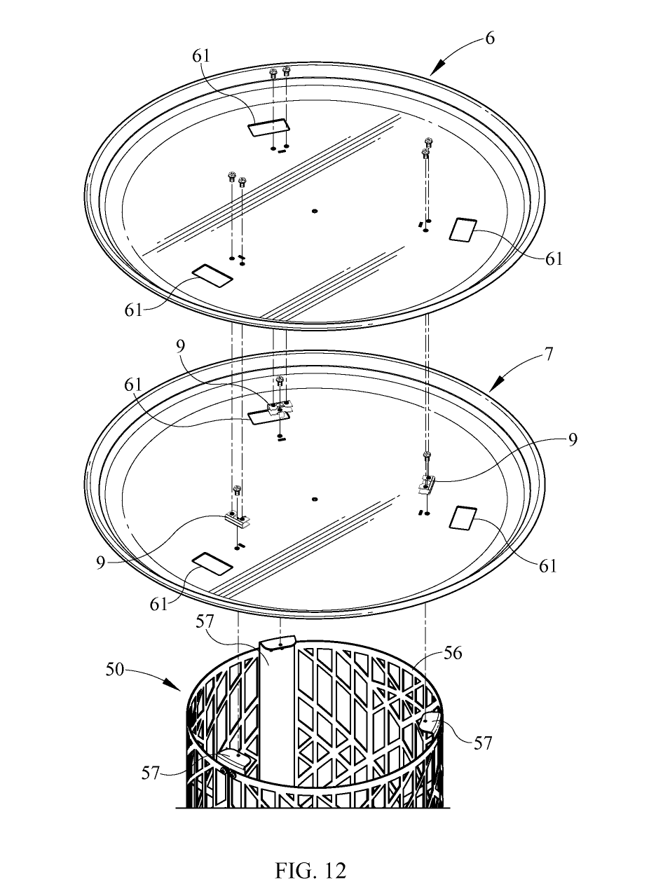

FIG. 12 shows one embodiment of the deflectors 6, 7 in more detail, illustrating them in the shape of a pan. In this embodiment, a top deflector pan 6 is located above a bottom deflector pan 7, and deflector brackets 9 separate the two pans 6, 7 from each other. Deflector brackets 9 also have holes in them through which the pans 6, 7 can be attached to each other, for example by screws, and in turn can be attached, also for example by screws, to grate pillars 57. Deflector pans 6, 7 also have deflector openings 61 through which the upper portions of support pillars 8a for attachment to corresponding lower portions of support pillars 8b. However, the pans are primarily intended to provide sufficient surface area over which heat may dissipate to guard against overheating of table 2. Preferably, the table 2 is made of a heat insulating material to further guard against overheating. Any number of deflector pans may be utilized in a variety of constructs as needed in order to maintain the temperature of the table 2 so that it is sufficiently cool for use.

The space between the pans 6, 7 created by deflector brackets 9 allows heat between the pans to dissipate so that the top deflector pan 6 is somewhat cooler than the bottom deflector pan 7. As shown in FIG. 12, the deflector pans 6, 7 are much wider than the circumference of grate 56 and the enclosed heating area 50 in order to deflect heat away from the large table 2 above them and towards the lower extremities of people standing or sitting around the table heater.

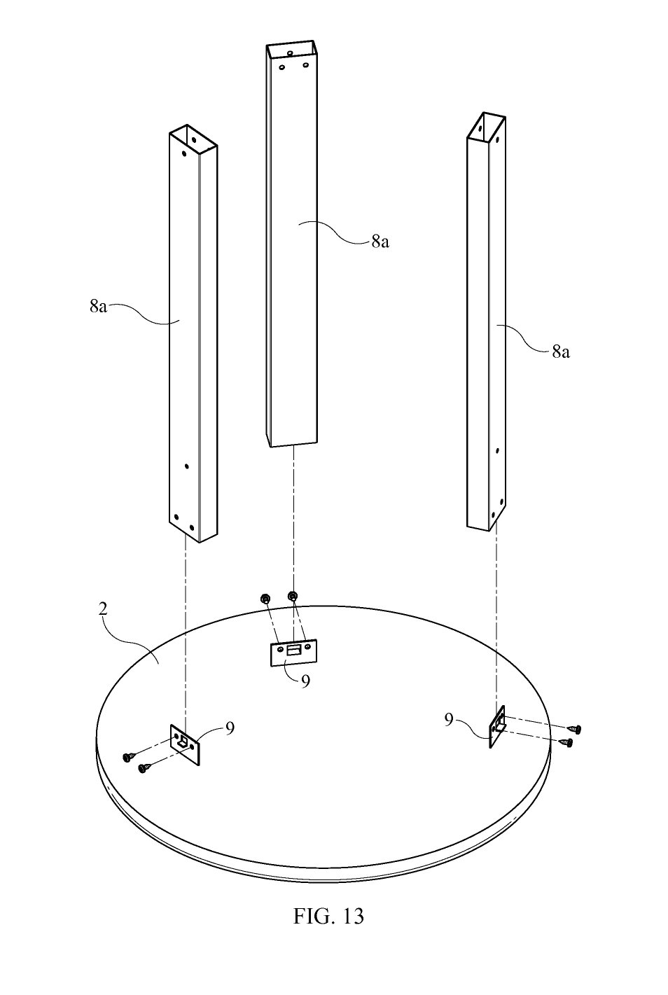

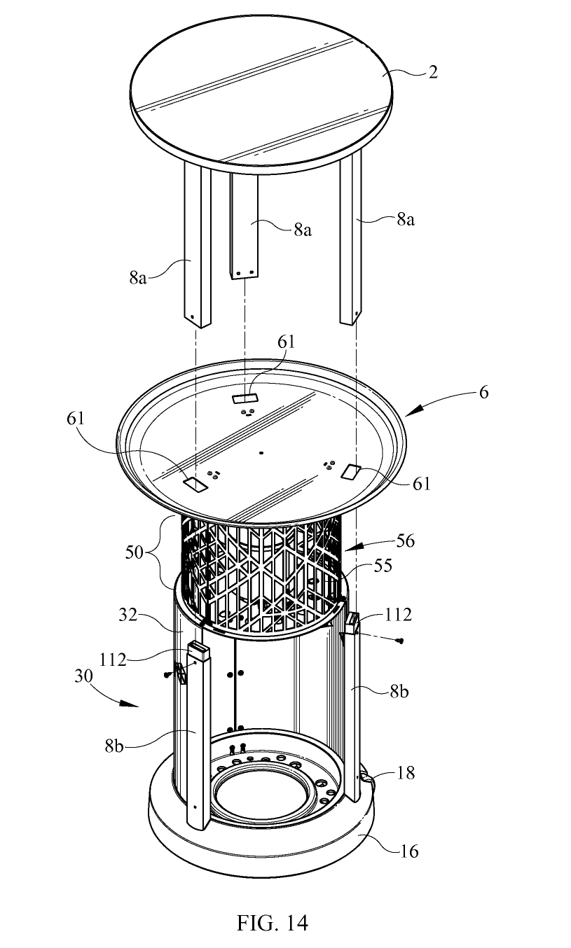

FIG. 13 shows an inverted view of the table 2 before the table 2 is attached to the rest of the table heater 1. The upper portions of support pillars 8 are attached to the table 2 by means of brackets 9 through use of screws or other fasteners, and extend vertically down the outside of the heating area 50 and grate 56 as shown in FIG. 14. After the upper portions of support pillars 8a are attached to the table 2, they can slide through deflector openings 61 and attach to the corresponding lower portions of support pillars 8b as shown in FIG. 1. The upper portions of support pillars may also be attached to grate 56 by appropriate means (not shown) for added support if desired.

As previously referred to with reference to FIGS. 1 and 5, the cabinet assembly 30 has an ignitor 14 and a control knob 12. The ignitor 14 and control knob 12 should be placed where they can respectively communicate with the ignitor electrode 74 and the energy source. It is normally most convenient to place them on the outside of the panels 32 of cabinet assembly 30, as shown in FIG. 1 to make them readily accessible to a user.

To light the burner 60, the control knob 12 is preferably designed to be pressed inward and turned to the start position. While the knob 12 is still pressed in, the ignitor 14 is then repeatedly pressed until the burner 60 is lit. After the burner 60 is lit, the control knob 12 is released. To adjust the heat level, the knob 12 can be rotated to adjust the control valve to the desired setting.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

We claim:

1. A combination table and pillar heater comprising:
a table;
a heating area below said table, wherein said heating area has at least one opening that allows heat to escape laterally from said heating area; and
at least one heat guard rail attached to said combination table and pillar heater and positioned away from said table.

2. The combination table and pillar heater of claim 1 further comprising at least one support pillar, wherein said heat guard rail is attached to said at least one support pillar.

3. The combination table and pillar heater of claim 1, said table comprising a table top, a table edge, and a table bottom, wherein said at least one guard rail is attached to said table edge.

4. The combination table and pillar heater of claim 1, said table comprising a table top, a table edge, and a table bottom, wherein said at least one guard rail is attached to said table top.

5. The combination table and pillar heater of claim 1, said table comprising a table top, a table edge, and a table bottom, wherein said at least one guard rail is attached to said table bottom.

6. The combination table and pillar heater of claim 1, wherein said at least one heat guard rail has an outside edge; and wherein said outside edge defines an extended area between said table and said outside edge.

7. The combination table and heater of claim 6, wherein said extended area is an open space.

8. The combination table and heater of claim 6, wherein said outside edge has a connection to said table.

9. The combination table and pillar heater of claim 1 further comprising:
a heat source within said heating area and below said table, wherein said heat source is positioned such that heat from said heat source dissipates laterally out said at least one opening.

10. The combination table and pillar heater of claim 1 further comprising at least one deflector pan positioned below said table.

11. The combination table and pillar heater of claim 4 further comprising:
a base;
a storage space situated between said heating area and said base; and
a housing that encloses said storage space.

12. The combination table and pillar heater of claim 9, wherein said heat source is a gas-powered radiant emitter.

13. The combination table and pillar heater of claim 9, wherein said heat source is a ring burner.

14. A portable combination table and heater comprising:
a cabinet;
a base adjacent to and supporting said cabinet;
a self-contained energy source positioned within said cabinet;
a heating area situated above said cabinet and having at least one lateral opening;
a heat source within said heating area;
an insulated table above said heating area; and
a heat guard rail attached to said table and extending outside the area encompassed by said heating area.

15. The portable combination table and heater of claim 11 further comprising at least one deflector pan positioned between said heat source and said table.

16. A heater comprising:
a non-heat conductive table mounted on a frame above at least one deflector;
a heat guard rail attached to said table and extending out from said table;
said at least one deflector forming the top of a heating chamber having at least one burner,
said heating chamber having a plurality of apertures allowing heat emanating from said burner to exit said chamber, wherein said table is separated from said burner by said deflector.

17. The heater of claim 16, further comprising a cabinet adjacent to and below said heating chamber.

18. The heater of claim 17, wherein an energy source for said burner is contained within said cabinet and said energy source is in flow communication with said burner.

19. The heater of claim 17, further comprising a base below said cabinet.

20. The heater of claim 19, wherein said base comprises wheels whereby said heater is portable.
